(19) United States
(12) Patent Application Publication
(10) Pub. No.: US 2001/0047273 A1
(43) Pub. Date: Nov. 29, 2001

(54) Electronic transaction clearing system

(76) Inventors: Edward Cooper Greer, Lower Gwynedd, PA (US); Govi Rao, Norristown, PA (US); Ratna Reddi, Woodbridge, NJ (US)

Correspondence Address: James V. Mahon, Esq., Clifford Chance Rogers & Wells LLP, 200 Park Avenue, New York, NY, 10016, US

(21) Appl. No.: 09/795,887

(22) Filed: Feb. 28, 2001

Related U.S. Application Data
(60) Provisional application No. 60/189,996, filed on Mar. 17, 2000.

(51) Int. Cl. G06F 17/60

(52) U.S. Cl. 705/1; 707/3

(57) ABSTRACT

Processing an e-commerce transaction includes querying a clearinghouse system to determine handling standards associated with a product. Upon receiving a query identifying a product and an entity, the clearinghouse computer system queries a database to determine whether the entity meets a product use and handling standards associated with the product. A response is then sent to the electronic commerce system indicating whether the first entity meets the applicable handling standards. The response may authorize or deny a pending transaction. Key functionality can be provided by a transaction processing system that includes a product database associating products with product handling standards, and a processing system coupled to the product database. The processing system can query the product database to identify product handling standards associated with identified products. The system can be coupled to an electronic commerce system to authorize transactions based on conformance of different entities with applicable product handling standards.

### CROSS-REFERENCE(S) TO RELATED APPLICATIONS

This application claims the benefit of the filing date of U.S. provisional application Ser. No. 60/189,996 entitled “Electronic Transaction Clearing System” which was filed on Mar. 17, 2000.

### BACKGROUND OF THE INVENTION

Electronic commerce (e-commerce) is changing the way in which industries provide business services. E-commerce web sites, web portals, and other electronic purchasing systems can provide rapid and fully automated arms-length purchasing transactions and comparison shopping. However, for products requiring specialized handling and care by sellers, purchasers, and other parties, the relatively anonymous and automated transactions of a traditional e-commerce system may impose cumbersome barriers to ensuring implementation of desired handling and care policies.

One industry in which handling and care policies are important is the chemical industry. Chemical manufacturers may sell chemicals that, alone or in combination, can present significant dangers. For this reason, the chemical industry has implemented a set of handling and care standards known as the Responsible Care® standards. The Responsible Care standards help to ensure that chemicals are properly handled throughout their life cycle; from manufacture to disposal. As part of a Responsible Care process, the proper authority to possess, and procedures to handle and use, particular chemical products is certified before the products are transferred between manufacturers, shippers, purchasers, users, and other parties.

Responsible Care standards are commonly enforced by manufacturer-implemented policies and procedures. For example, when a hazardous chemical product is transferred from a manufacturer to a purchaser, the manufacturer may manually check records or initiate on-site inspections to ensure that all parties (i.e., shippers, intermediate warehouses, and the ultimate recipient of the purchased product) are properly certified to receive and handle the product. If a party is unable to meet Responsible Care standards, that party is typically excluded from a transaction (alternatively, training, licensing, and/or other certification activities must be completed before the excluded party can participate in the transaction). Responsible Care certification by manufacturers and manual checking of records can be a time consuming and expensive process. Such a process may not be compatible with the rapid processing goals and relatively anonymous nature of e-commerce transactions. As a result, conventional manual implementations of such fitness-for-use and handling processes can impeding e-commerce transactions.

### SUMMARY OF THE INVENTION

In general, in one aspect, the invention features a computer-implemented method of processing e-commerce transactions. The method includes processing a query at a clearinghouse computer system to determine whether use and handling standards for a product can be met by a purchaser (or other entity handling the product). The query may be generated at an e-commerce system during processing of a purchase transaction, and the clearinghouse computer system may send a response to the e-commerce system authorizing or denying the transaction.

In general, in another aspect, the invention features a computer-implemented transaction processing method that includes interaction between an electronic commerce computer system and a user to generate transaction data that includes a product identifier. An authorization query is generated based on the interaction with the user and sent to a clearinghouse computer system. The clearinghouse computer system processes the authorization query to determine a handling standard associated with the identified product. The electronic commerce system thereafter receives a response from the clearinghouse computer system containing authorization data.

In general, in another aspect, the invention features a transaction processing system. The system includes a product database storing data that associates products with product handling standard, and a processing system coupled to the product database. The processing system can query the product database to identify product handling standards associated with identified products. The system can be coupled to an electronic commerce system to authorize transactions based on conformance of different entities with applicable product handling standards. Implementations may also include an entity database identifying different entities that may be involved in the handling of products and compliance of each of the entities with at least one handling standard. Compliance may be determined, e.g., based on results of an independent certification process. Data request received at the system may identify particular entities; in such cases, the processing system may querying the entity database to determine compliance of an identified entity with the a handling standard for a particular product. The system may thereafter return a response to a e-commerce system indicating whether a particular transaction is authorized.

Implementations may include one or more of the following features. Queries can be generated at the e-commerce system in response to processing of a purchase transaction. When the clearinghouse system determines that an entity fails to meet a handling standard associated with a product, a response can be sent from the clearinghouse system to the e-commerce system to deny the transaction. Entities may be, e.g., individuals, corporations, shippers, intermediate product handlers, end-users or others. The clearinghouse data can include product data records that associate products with handling standards.

Implementations may also include one or more of the following features. If an entity has not been certified as meeting a particular handling standard, a certification process may be automatically initiated by the clearinghouse system. Product identifiers can identify products and/or groups of products having similar characteristics (e.g., a group of chemicals with similar chemical characteristics and governed by a common handling standard).

Implementations may include one or more of the following advantages. Manufacturers can sell products using automated e-commerce systems while automatically ensuring that all such transactions meet industry standards of care and best practice guidelines. For example, in the chemical industry, the applicable handling standard may be based on Responsible Care® requirements. Multiple vendors can interface with, and contribute to, a single database system to enable efficient certification of standards compliance. Safety and environmental responsibilities may more easily be ensured. Control in qualifying customers and shippers for the responsible use of products can be ensured, thus limiting liability. Can easily enforce a uniform standard of care on multiple sales channels, both internet and traditional (“bricks-and-mortar”) stores. Products may be positioned differently in different markets, while ensuring that the standards of each marketplace are met. Data regarding customer purchases can be aggregated and analyzed to detect market issues (e.g., gray market distribution) and perform other market analysis. Manufacturers can outsource their care and standards procedures to an independent clearinghouse to reduce administration cost and overhead. Industry participants can join together with other participants to collectively, rather than individually, certify standard adherence by customers, thus lowering certification cost and pooling risk. E-commerce sites can address standard of care issues in a low-cost, frictionless electronic transaction, thus limiting their liability.

Advantages may also include one or more of the following. Customers may receive rapid approval of transactions requiring standard of care certification. Customers can use different approved e-commerce sites to purchase a material for which they are qualified; individual approvals at every e-Commerce site are not necessary. This may help lower transaction cost resulting from passed-on procurement chain efficiencies by the supplier and intermediary. Customers benefit from lower costs if sellers pool certification data (customers are only certified once.) Increase the number of suppliers who will sell to them once they become certified.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIG. 1 is an network block diagram.

FIG. 2 is a flowchart.

### DETAILED DESCRIPTION OF THE INVENTION

A clearinghouse database can be integrated with an e-commerce system and used to help ensure that product use, handling, and care standards are met when products are sold using an e-commerce system. To help ensure that such “handling standards” are met, the clearinghouse database processes data identifying purchasers, products, and product categories using stored business logic that describes the care and handling standards applicable to the products and product categories applicable to a particular transaction. The clearinghouse database can also process data describing the use, care, and handling capabilities of various purchasers to ensure that the applicable standards can be met by a purchaser.

In the description that follows, an implementation of an exemplary clearinghouse database system for use in e-commerce chemical transactions is described. In this exemplary implementation, the clearinghouse database system (referred to as the “CareCert” database system) stores data used to ensure that the chemical industry's Responsible Care standards are met for products sold by e-commerce methods. The CareCert database system may be a system that is independently accessible by various participants in, and implementers of, Internet-based e-commerce systems. The functionality of the CareCert database system may be used to automatically integrate Responsible Care® standards verification with automated and distributed e-commerce chemical product purchase order processing.

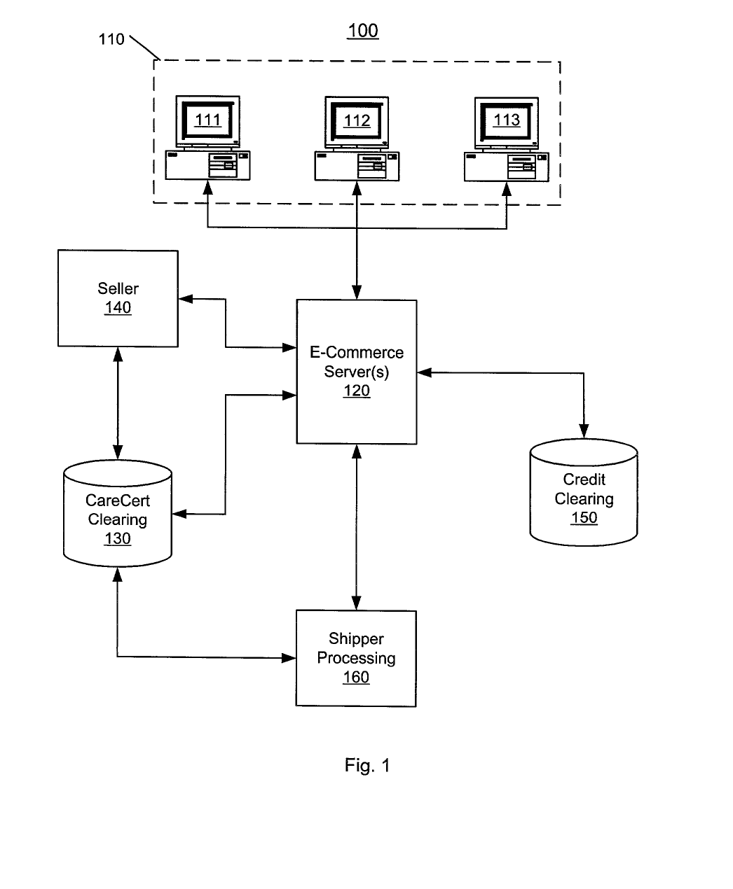

FIG. 1 shows a computer network 100 that include an e-commerce server 120 connected to the CareCert clearinghouse database 130 and to one or more user terminals 111-113. The e-commerce server 120 also may be connected to a credit clearinghouse database system 150, an reseller's or manufacturer's order processing system 140, and a shipper's (i.e., a common carrier's) order processing system 150. Links interconnecting the components 110, 120, 130, 140, 150, 160 can be links through an intermediate network such as the Internet. Consequently, the system 100 may include additional data transmitting and processing elements.

In a world-wide-web based implementation, the e-commerce server 120 and user terminals 111-113 can include software implementing the Hypertext Transfer Protocol (HTTP). HTTP is one of a variety of protocols that can be used to exchange data between computer systems and data processing equipment on a data network. E-commerce server 120 can process and generate data associated with product purchase transactions, and can operate as a repository of product information. Data stored at, and/or generated by, the server 120 can be retrieved by the web clients 111-113, processed, and presented to users.

The e-commerce server 120 can send purchase order data to, and retrieves purchase order data from, user terminals 111-113. The purchase order data sent to user terminals 111-113 can include, e.g., product catalogs, pricing, and manufacture information. Purchase order data can also be received by the e-commerce system 120 from the user terminals 111-113. The purchase order data include queries about particular products, purchaser identification information, an selection of a desired product and product volume, shipping address information, a designation of a preferred shipper, and a designation of a preferred manufacturer. Naturally, other conventional e-commerce data also can be exchanged between the e-commerce server 120 and the user terminals 111-113.

The e-commerce server 120 may act as a “portal” that is interconnected with one or more seller 140, shipper 160, and credit clearinghouse systems 150. For example, the e-commerce system 120 may receive purchase order information via a purchaser's entry at a terminal 110 and verify the purchaser's credit by interacting with a credit card transaction clearinghouse system 150. Interaction with a credit clearinghouse system 150 can also include electronically drawing funds (i.e., via a bank or ATM network), receiving credit approvals, determining credit limits, determining available credit, and performing other payment processing. The e-commerce system 120 also may exchange data with a shipping system 160 and with a manufacturer or reseller 140. Data exchanged with such systems 160, 140 can be used to schedule merchandise pick-up and delivery, to confirm stock levels, determine pricing, and/or for other purposes. Alternatively, the e-commerce system may integrate one or more functions of the credit clearinghouse 150, seller 140, and shipper 160 systems. Conventional aspects of E-commerce server 120 (e.g., presenting products to a user, handling payments, and interfacing with external shipping and management systems) may be handled using known E-commerce system technologies and platforms. For example, Apple WebObjects(r), Lotus Domino(r), and/or Sun-Netscape alliance iPlanet™ software may be used to interact with customers and receive purchase order data.

According to the invention, e-commerce server 120 also includes an interface to the CareCert database system 130. The CareCert database 130 provides data enabling a e-commerce server 120 to verify that Responsible Care® standards applicable to products, purchasers, common carriers, and other parties are met. To do so, the CareCert database is provisioned with Responsible Care® certification and compliance data associated with the relevant suppliers, customers, shippers, and products. In some cases, this compliance data may be specific to a particular application of a product. Using the provisioned data, the CareCert database 130 can respond to queries concerning certification status of combinations of customers, products, product applications, suppliers, and shippers. For example, an e-commerce site 120 or a manufacturer, reseller, or other product provider 140, can send a query identifying a purchaser interested in buying a particular product for a particular application. The CareCert database 130 can process the query and respond indicating whether the shipper, purchaser and other parties, along and in combination, have met associated Responsible Care standard. The response from the CareCert database 130 may, for example, be in the form of an extensible markup language (XML) response containing a XML tagged identification of each party, the certification status of each identified party, and the certification status of one or more possible combinations of parties needed to complete a transaction. Similarly, an e-commerce site may send a query identifying a desired product and a purchaser of that product; the CareCert database 130 response to the query can indicate the purchaser's certification status and can identify one or more shippers and sellers certified to ship and sell the desired product.

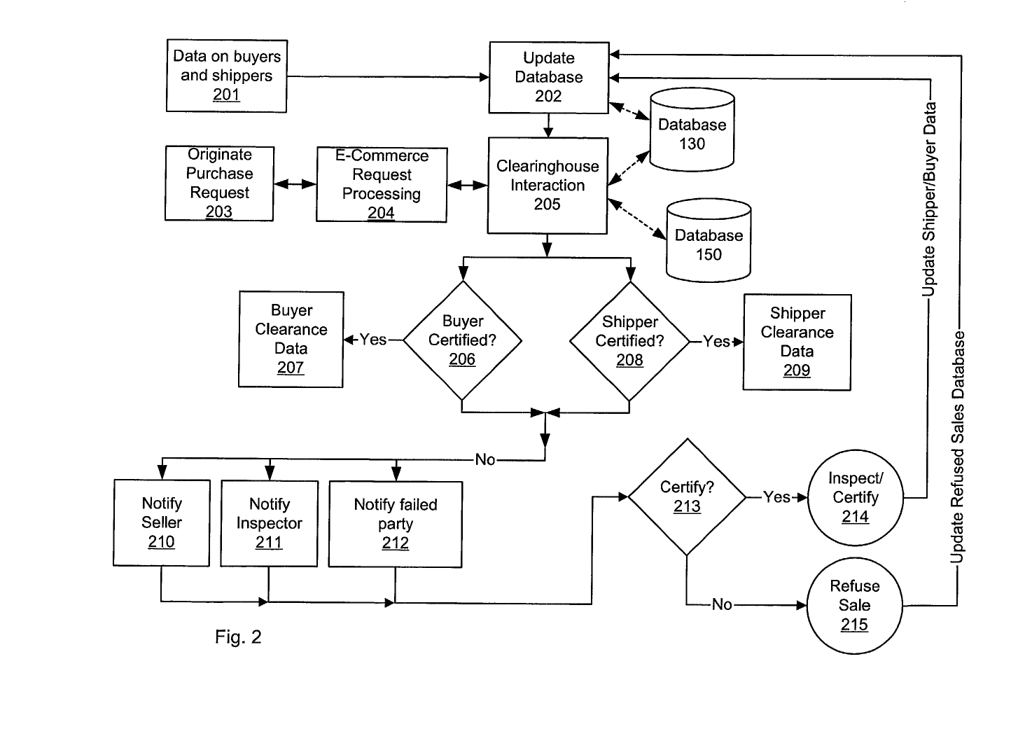

FIG. 2 shows operations of an exemplary e-commerce chemical purchasing system that include using an implementation of the CareCert database 130. It should be recognized that, in other implementations, particular stages 201-215 may be performed in a different order, may be eliminated, or may be supplemented by other processes.

In a data gathering and provisioning stage 201, Responsible Care certification information is determined. Processes to determine the Responsible Care certification information may differ by product, product category, and application. For hazardous chemical products, certification of a purchaser may require an on-site visit to ensure that proper safety and product containment procedures and product use equipment are in place and operational, that employees have been trained to safely use the product, and to determine estimated product use and processing rates to help ensure that dangerous stockpiling does not occur. For a relatively benign product and application, such as the sale of small volumes of sand for use in a sandbox, the applicable standards of care may require little or no checking; on the other hand, for the sale of sand for use in a sand-blasting application, or for large volume sales for construction applications, a purchaser may be certified to ensure that proper training and handling procedures are in place so as to prevent silicosis hazards. Thus, different certification standards may apply depending on the application of a particular product. After certification data is gathered, the CareCert database 130 is provisioned (updated) with the new data (step 202).

Data in the CareCert database may be accessed during a transaction between a purchaser and an e-commerce server. A purchase transaction can be initiated by a purchaser at a web terminal 111. Data (i.e., HTML web pages) may be exchanged between e-commerce site 120 and the purchaser's terminal 111 to present available products to a purchaser and to receive an order from the purchaser (steps 203 and 204). Order data received from the purchaser at the e-commerce server may identify the product to be purchased, a quantity, and credit information. In some cases, the purchaser also may identify a specific application for the product. Alternatively, the CareCert database 130 may be provisioned with data identifying a purchaser's application for a particular product. The CareCert database system may automatically determine the appropriate Responsible Care standards associated with a particular purchaser and product based on the information about particular purchaser's applications of the product. Additionally, the purchaser may identify a preferred shipper (in some cases, by selecting from a predetermined list) or may provide other delivery instructions.

In processing the purchase order data (step 204), the e-commerce server 120 queries the CareCert database 130 to determine whether a transaction conforms to Responsible Care standards (step 205). The certification query from the e-commerce site 120 to the CareCert database 130 may identify, among other things, the product being purchased and the purchaser. Additional data, such as an identity of a shipper, the volume being purchased, and the product's application, also may be provided. The CareCert database system 130 processes the certification query by retrieving stored data indicating whether the purchaser is certified to purchase the identified product.

In a relational database implementation, data needed to process the certification query can be stored in one or more data tables. The data tables can include records associating purchasers with certification status information for particular products and/or product classes. The database system 130 may implement a relational database query using purchaser and product identity information to determine the purchaser's certification status. In some cases, a particular product may be a member of a product class with similar characteristics. In such cases, a purchaser may be certified for the product class. To process a certification query, the database system 130 may first determine a product class associated with a particular product to be purchased, and then determine the purchaser's certification for the determined product class. If a shipper or other party has also been identified in the certification query, the database will similarly determine if the shipper has been certified to handle the product. A query response containing certification status information can then be returned to the e-commerce server 120.

In some cases, a certification query may be sent from an e-commerce site 120 to the database 130 to determine, e.g., particular manufacturers or shippers of a product. For example, a certification query received by the CareCert database system 130 can identify a product and a purchaser and can request an identification of certified shippers and certified manufacturers of the product. In response, the CareCert database system 130 can return a list identifying certified shippers and manufacturers. Additional data exchanges between the purchaser and e-commerce site may be used to present shipper and manufacturer choices to the purchaser, and to receive the purchaser's selection of a particular choice. In some cases, the CareCert database may include links to manufacturer 140 and/or shipper 160 databases to obtain additional data such as product pricing and shipment information. Such additional data also can be sent to the e-commerce site 120 for processing and presentation to a purchaser. Alternatively, such additional data may be pre-provisioned at the CareCert database.

After receiving purchaser certification information from the CareCert database 130, the e-commerce site 120 can process the certification data to determine if the purchaser and other parties (e.g., a shipper) are properly certified (steps 206 and 208). If the purchaser and shipper are properly certified, the e-commerce site 120 can permit them to participate in a particular e-commerce transaction (steps 207, 208). After the e-commerce site 120 determines that all parties are properly certified, the site 120 can complete order processing. Completing order processing can include interacting with, and automatically sending data to, the seller, shipper, purchaser, credit clearinghouse and other parties to arrange for shipping and delivery of the product and to pay for the product.

If the e-commerce site determines that the purchaser, shipper, and/or other party is not properly certified, notices may be generated by the CareCert database system 130 (or by the e-commerce site 120) and sent to the seller (step 210), an independent certification agency (step 211), and/or the non-certified party (step 212). The notices sent to the seller, certification agency, and non-certified party can identify, e.g., information about the failed order including the purchaser and the order volume. The seller, certification agency, purchaser, or other party may evaluate this information to determine if certification of the failed party should be initiated (step 213). This notification mechanism may allow smaller shippers and purchases, who may not otherwise be certified by a large manufacturers, to obtain certification and, thereby, to participate in a marketplace that may have been previously inaccessible. For example, a seller may pay to certify a purchaser if the order volume is large; a shipper may pay an independent certification agency to obtain certification so as to be able to participate in the current transaction or in future similar transitions; and a buyer may pay to obtain certification so as to be able to participate in e-commerce transactions. If a party seeks certification, an inspection process may take place (step 214). As a result of the certification process (step 214), the CareCert database may be updated (step 202). Alternatively, if the party refuses to obtain certification, the sale is refused (step 215) and the CareCert database can be updated with refused sale information.

In addition to certification functions, the CareCert database may record purchase volumes, purchasers, shippers, products and other information associated with completed and failed transactions. This information may be used for, e.g., data mining, marketing, trend tracking, sale forecasting, and hazard prevention purposes. For example, to prevent hazards, the CareCert database may check for chemical hazards that may be present based on previously purchased products in combination with current purchase products. If a hazard is detected, the CareCert system can generate a warning or detailed handling instructions informing the purchaser that special handling of the purchased products (e.g., segregated storage from the previously purchased products) will be necessary.

Implementations can change details of the processes and systems described herein so as to adapt systems and techniques of the invention to different industries, and to the evolution of the e-Commerce marketplace and technologies.

The CareCert system 130 can include data that prioritizes listings of returned shippers, manufacturers, and other parties. In processing a query to determine certified shippers of a particular product, the CareCert system 130 may prioritize shippers listed in a query response based on their on-time delivery, on cost for shipping to a particular location, based on join sponsorship agreements, or based on other criteria. The e-commerce system 120 can process the priority information to automatically select from among multiple certified parties and/or to order choices presented to a purchaser.

Processing and presentation of the data at user terminals may be performed by web browser software such as Microsoft Internet Explorer Version 5.0, a Netscape Navigator Version 4.0 browser, or other client software products such as a Lotus Notes client or a Microsoft Outlook client. Data processing and presentation by a browser may conform to requirements of standardized data formatting protocols, such as the Hypertext Markup Language (HTML), Dynamic HTML (DHTML), or Extensible Markup Language (XML). Browsers also may provide for the download and execution of software, such as through the use of a Java® Virtual Machine to execute Java programs. Other data formatting and presentation protocols, other programming languages, and rich media data such as audio, video, and animation files also can be exchanged between the server and clients and processed by browser software or by other client software (e.g., by a Java program).

Each computer systems described herein may be implemented using a single-processor computer or a multi-processor computers. Multi-processor computers can include tightly coupled computer systems, such as symmetric multi-processor computer systems, as well as loosely coupled computer clusters and geographically distributed computers connected by a network. Database systems may be implemented as a sub-component of a computer system that also provides other processing functions (e.g., a database may be implemented using storage media coupled to a computer processing business logic). Databases can also be implemented using dedicated database servers and storage. Processing and database systems may be implemented as distributed systems. For example, although presented as a single logical system, the CareCert database system 150 may include a number of physically separate database systems each having their own computer processing and data storage facilities. A database can also include a data structure stored in a transitory memory, such as a data structure stored in RAM memory.

The invention may be implemented in digital electronic circuitry, or in computer hardware, firmware, software, or in combinations of them. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output. The invention may advantageously be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application-specific integrated circuits).

A number of embodiments of the present invention have been described. Nevertheless, it will be understood that various modifications may be made without departing from the spirit and scope of the invention. For example, the disclosure herein describes, as an example, a clearinghouse database system implemented for use in an e-commerce system adhering to ResponsibleCare® chemical purchasing and handling guidelines. Such a clearinghouse database system could be implemented for other product use and certification purposes. For example, a consumer could ensure that all articles he buys are made only in certain countries or are certified to have been made without the use of child labor; a household could enter information about occupants, such as children's ages, and when purchasing toys and other products, a clearinghouse database could be used provide warnings about toys or other products that may pose hazards to young children; computer parts could be sold only if they fit in the computer for which they are intended; cell phones could be sold only if the appropriate cellular network is present in a purchaser's geographic region; types of bottles could be selected based on the areas in which they are recyclable or returnable; manufacturers could be selected on the basis of their International Standards Organization (ISO) certification; consumer goods could be bought based on the use of particular chemicals in their manufacturing process; airline tickets could be purchased on the basis of the history of on-time arrival of a particular airline between particular take off and landing locations and particular travel times; prescription drug and medial devices could be sold to buyers based on prescription data securely received from doctors. Accordingly, other embodiments are within the scope of the following claims.

What is claimed is:

1. A computer-implemented transaction processing method comprising:
receiving a query at a clearinghouse computer system from an electronic commerce system, the query identifying a product and a first entity;
processing clearinghouse data to determine whether the first entity meets a handling standard associated with the identified product; and
sending a response to the electronic commerce system indicating whether the first entity meets the applicable handling standard.

2. The method of claim 1 wherein:
the query is generated at the electronic commerce system in response to processing of a purchase transaction; and
when the clearinghouse system determines that the first entity fails to meet the handling standard associated with the product, the response indicates denial of the purchase transaction.

3. The method of claim 1 wherein the first entity comprises an entity selected from the group consisting of an individual, a corporation, a shipper, an intermediate product handler, and an end-user.

4. The method of claim 1 wherein:
the clearinghouse data comprises product data records comprising a product identifier and a handling standard identifier identifying a hazard avoidance standard;
determining whether the first entity meets requirements of the handling standard further comprises querying a entity database identifying entities meeting requirements of the handling standard.

5. The method of claim 4 further comprising:
when the entity database does not comprise data indicating status of the first entity with respect to the handling standard, automatically initiating a certification process to determine if the first entity meets the handling standard.

6. The method of claim 4 wherein each product identifier comprises a chemical product identifier.

7. The method of claim 6 wherein at least one chemical product identifier identifies a group of chemicals associated with a common handling standard.

8. A computer implemented transaction processing method comprising:
at an electronic commerce computer system, interacting over a network with a user to generate transaction data comprising a product identifier;
sending from the electronic commerce computer system to a clearinghouse computer system an authorization query requesting authorization of a transaction based on a handling standard associated with the identified product; and
receiving at the electronic commerce computer system a response from the clearinghouse computer system, the response comprising authorization data generated at the clearinghouse in response to the authorization query.

9. The method of claim 8 wherein interacting with a user comprises exchanging data between the electronic commerce computer system and a web browser.

10. The method of claim 8 wherein the entity comprises the user.

11. The method of claim 8 wherein the entity comprises an intermediate handling entity taking physical possession of the product from a supplier prior to delivery of the product to the user.

12. The method of claim 11 wherein the intermediate handling entity comprises a common carrier.

13. A transaction processing system comprising:
a product database comprising data associating each of a plurality of products with a product handling standard; and
a processing system operatively coupled to the product database and configured to:
receive a data request from a first one of the electronic commerce systems, the data request comprising a product identifier; and
querying the product database to identify a product handling standard associated with the identified product.

14. The system of 13 wherein each handling standard comprises a standard for avoidance of a hazardous condition.

15. The system of claim 14 wherein each handling standard comprises a handling standard applicable to at least one chemical product.

16. The system of claim 14 further comprising:
an entity database identifying a plurality of entities and indicating compliance of each of the entities with at least one handling standard; and wherein
each data request further comprises an entity identifier; and
the processing system is further configured to process each data request by querying the entity database to determine compliance of an identified entity with the first handling standard.

17. The system of claim 16 wherein the processing system is further configured to transmit a response to the first electronic commerce system indicating whether the identified entity complies with a handling standard applicable to the identified product.

18. The system of claim 17 wherein the first entity comprises an entity selected from the group consisting of an individual, a corporation, a shipper, an intermediate product handler, and an end-user.
